(19) United States
(12) Patent Application Publication
(10) Pub. No.: US 2014/0312203 A1
(43) Pub. Date: Oct. 23, 2014

(54) VENDING MACHINE SUPPORTING APPARATUS

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: TING-TING HE, Wuhan (CN); ZHI-PING WU, Wuhan (CN); CHAO LIU, Wuhan (CN)

(73) Assignees: HON HAI PRECISION INDUSTRY CO., LTD., New Taipei (TW); HONG FU JIN PRECISION INDUSTRY (WuHan) CO., LTD., Wuhan (CN)

(21) Appl. No.: 14/093,619

(22) Filed: Dec. 2, 2013

(30) Foreign Application Priority Data
Apr. 18, 2013 (CN) 2013101348737

(51) Int. Cl. F16M 1/00

(52) U.S. Cl. CPC F16M 1/00
USPC 248/677

(57) ABSTRACT

A vending machine supporting apparatus includes a frame and a supporting assembly. The frame includes two first poles and two second poles connected between the two first poles. Each of the two first poles includes a first top piece and a first bottom piece parallel to the first top piece. The first bottom piece defines a first through hole. The first top piece defines a second through hole. The supporting assembly includes a supporting pillar and two fasteners. The supporting pillar includes a shaft portion and a map portion connected to the shaft portion. Each of the fasteners defines a securing hole. The two fasteners are located on opposite sides of the first bottom piece. The shaft portion is inserted in the first through hole, the second through hole and mounted in the securing holes of the two fasteners, and the map portion supported on ground.

### BACKGROUND

1. Technical Field

The present disclosure relates to a supporting apparatus for supporting a vending machine.

2. Description of Related Art

Vending machines are often equipped with a supporting apparatus to support devices and goods in the vending machine. Usually a vending machine stores a lot of devices and goods, the supporting apparatus should have a high strength to support a weight of a fully loaded vending machine. To reinforce the strength of the supporting apparatus, the supporting apparatus is manufactured to be heavy.

Therefore, there is room for improvement in art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an isometric, exploded view of an embodiment of a vending machine supporting apparatus.

FIG. 2 is an enlarged view of the circle II of FIG. 1.

FIG. 3 is an assembled view of the supporting apparatus of FIG. 1.

FIG. 4 is an enlarged view of the circle IV of FIG. 3.

FIG. 5 is another assembled view of the supporting apparatus of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

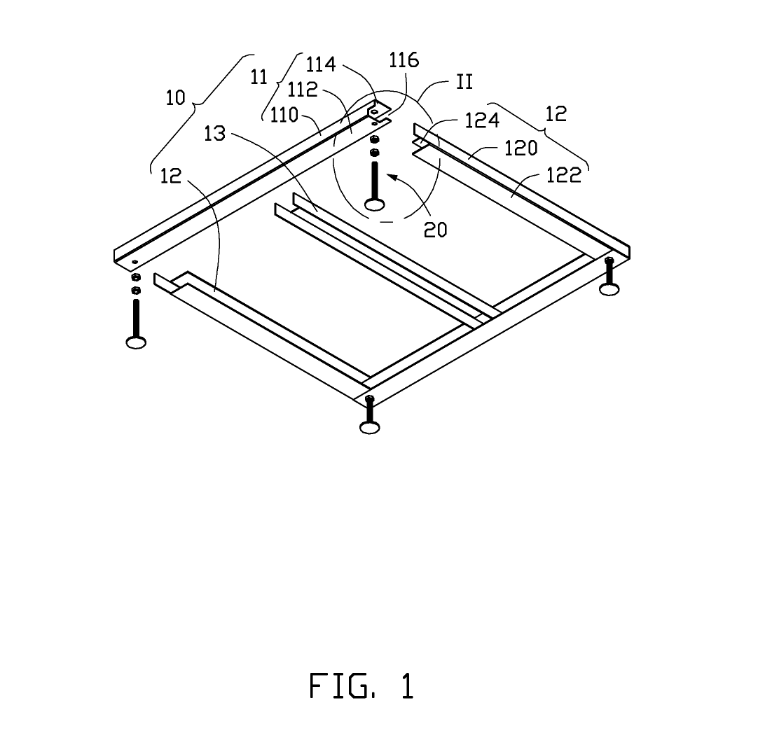

FIG. 1 shows that an embodiment of a vending machine supporting apparatus.

The supporting apparatus includes a frame 10 and four supporting assemblies 20.

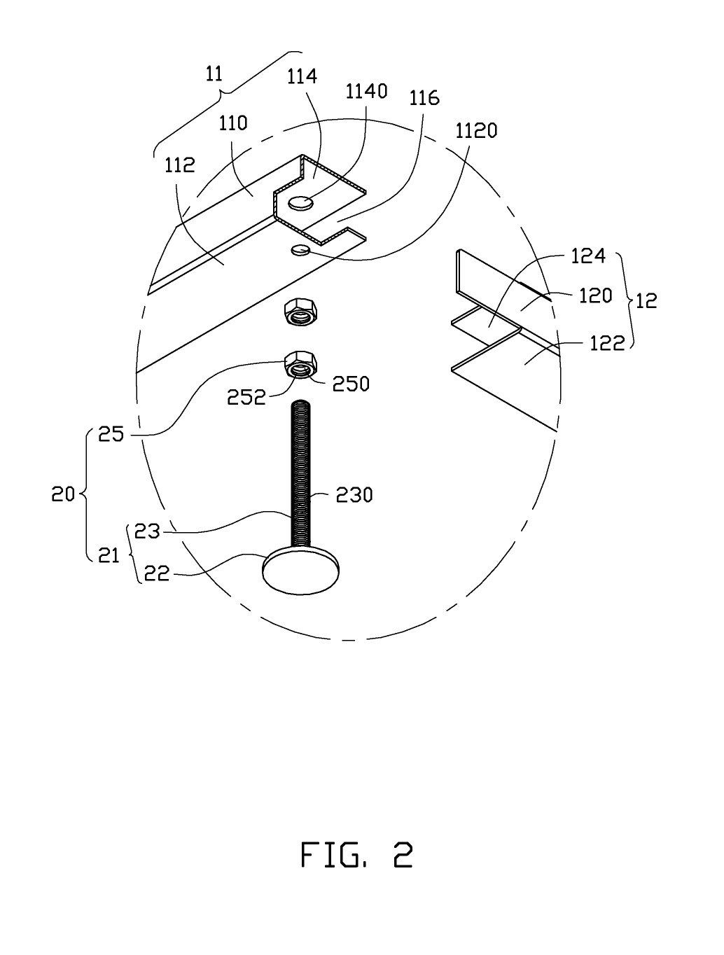

FIGS. 1 and 2 show that the frame 10 includes two parallel first poles 11, two parallel second poles 12, and a connecting pole 13. The first pole 11 is perpendicular to the second pole 12. The connecting pole 13 is parallel to the second pole 12. The first pole 11 includes a first side piece 110, a first bottom piece 112 perpendicularly connected to a bottom edge of the first side piece 110, and a first top piece 114 perpendicularly connected to a top edge of the first side piece 110. The first bottom piece 112 is parallel to the first top piece 114. The first side piece 110, the first top piece 114, and the bottom piece 112 together define a receiving space 116. Each end of the first bottom piece 112 defines a first through hole 1120. Each end of the first top piece 114 defines a second through hole 1140. The second through hole 1140 is aligned to the first through hole 1120.

The second pole 12 includes a second side piece 120, a second bottom piece 122 perpendicularly connected to a bottom edge of the second side piece 120, and a second top piece 124 perpendicularly connected to a top edge of the second side piece 120.

Each end of the connecting pole 13 can be received in the receiving space 116 of the first pole 11.

The supporting assembly 20 includes a supporting pillar 21 and two fasteners 25. The supporting pillar 21 includes a map portion 22 and a shaft portion 23 connected to the map portion 22. The shaft portion 23 includes a plurality of external screw threads 230. The fastener 25 defines a securing hole 250. The fastener 25 includes a plurality of inner screw threads 252 in the securing hole 250.

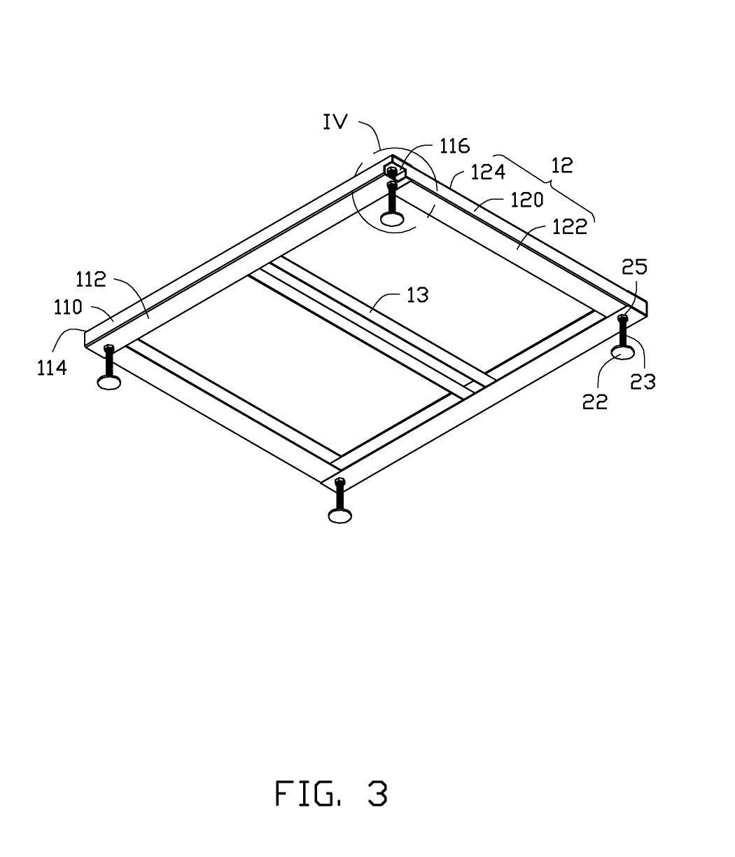

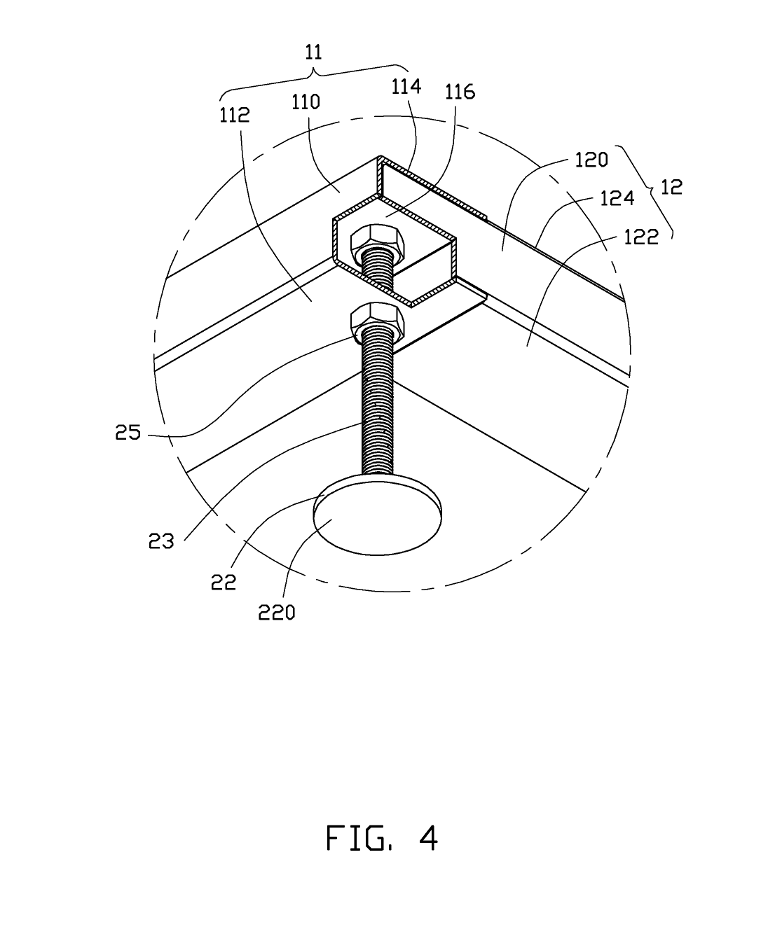

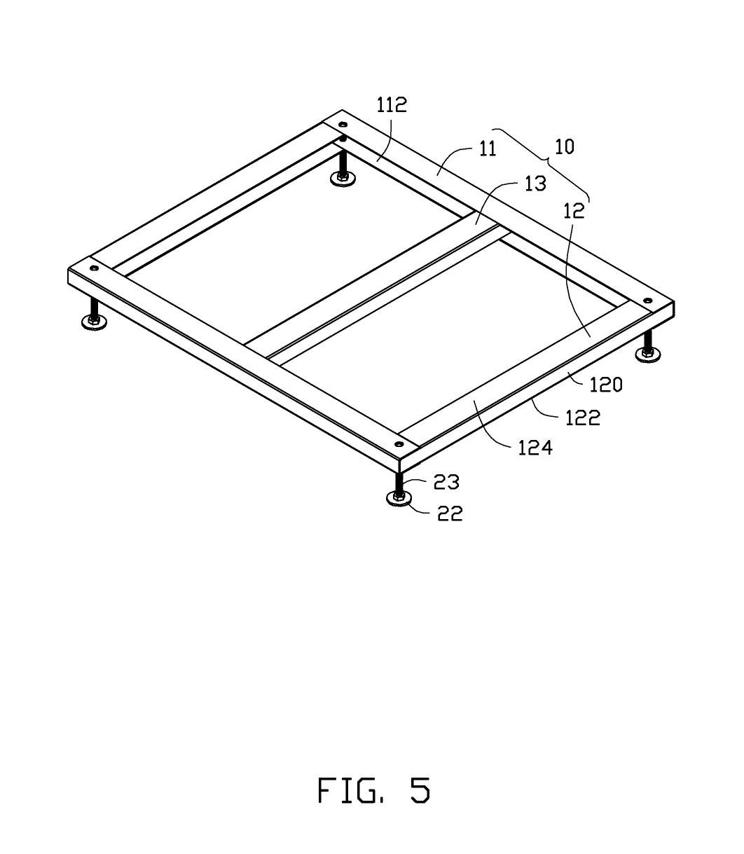

Referring to FIGS. 3 to 5, in assembly, the two first poles 11 and the two second poles 12 are mounted together by welding, or riveting, for example. One fastener 25 is located below the first bottom piece 112, and another fastener 25 is located in the receiving space 116. The securing holes 250 of the two fasteners 25 are aligned to the first through hole 1120 of the first pole 11. The shaft portion 23 of the supporting pillar 21 is inserted in the first through hole 1120 and the second through hole 1140 and simultaneously screwed in the securing holes 250 of the two fasteners 25. The external screw thread 230 engages the inner screw thread 252 to mount the supporting pillar 21 on the frame 10. After the four supporting pillars 21 are mounted on the frame 10, the map portions 22 of the four supporting pillars 21 are placed on ground to support the frame 10.

In the above supporting apparatus, the screw structure is used to support the frame 10 and the vending machine, which is light and has enough strength to support the vending machine.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A vending machine supporting apparatus, comprising:
a frame comprising two first poles and two second poles connected between the two first poles, each of the two first poles comprising a first top piece and a first bottom piece parallel to the first top piece, the first bottom piece defining a first through hole, the first top piece defining a second through hole; and
a supporting assembly comprising a supporting pillar and two fasteners, the supporting pillar comprising a shaft portion and a map portion connected to the shaft portion, each of the two fasteners defining a securing hole, the two fasteners being located on opposite sides of the first bottom piece, the shaft portion being inserted in the first through hole and the second through hole and mounted in the securing holes of the two fasteners, and the map portion being supported on ground.

2. The supporting apparatus of claim 1, wherein the shaft portion is perpendicular to the map portion.

3. The supporting apparatus of claim 1, wherein the first pole further comprises a first side piece perpendicularly connected to the first top piece and the first bottom piece.

4. The supporting apparatus of claim 3, wherein the map portion is parallel to the first bottom piece.

5. The supporting apparatus of claim 3, wherein the frame further comprises a connecting pole; the first side piece, the first top piece, and the first bottom piece together define a receiving space; and an end of the connecting pole is placed in the receiving space.

6. The supporting apparatus of claim 1, wherein the second pole comprises a second side piece, a second bottom piece connected to a bottom edge of the second side piece, and a second top piece connected to a top edge of the second side piece.

7. The supporting apparatus of claim 6, wherein the second top piece is parallel to the second bottom piece.

8. The supporting apparatus of claim 7, wherein the second side piece is perpendicular to the second top piece and the second bottom piece.

9. A vending machine supporting apparatus, comprising:
a frame comprising two first poles and two second poles connected between the two first poles, each of the two first poles comprising a first top piece and a first bottom piece parallel to the first top piece, the first bottom piece defining a first through hole, the first top piece defining a second through hole; and
a supporting assembly comprising a supporting pillar and two fasteners, the supporting pillar comprising a shaft portion and a map portion connected to the shaft portion, each of the fasteners defining a securing hole, one of the two fasteners being secured to the first top piece and another one of the two fastener secured to the first bottom piece, the shaft portion being mounted in the first through hole, the second through hole and the securing holes of the two fasteners to secure the supporting pillar on the frame, and the map portion being supported on ground.

10. The supporting apparatus of claim 9, wherein the shaft portion is perpendicularly connected to the map portion.

11. The supporting apparatus of claim 9, wherein the first pole further comprises a first side piece perpendicularly connected to the first top piece and the first bottom piece.

12. The supporting apparatus of claim 11, wherein the map portion is parallel to the first bottom piece.

13. The supporting apparatus of claim 11, wherein the frame further comprises a connecting pole, the first side piece, the first top piece, and the first bottom piece together define a receiving space, and an end of the connecting pole is placed in the receiving space.

14. The supporting apparatus of claim 9, wherein the second pole comprises a second side piece, a second bottom piece connected to a bottom edge of the second side piece, and a second top piece connected to a top edge of the second side piece.

15. The supporting apparatus of claim 14, wherein the second top piece is parallel to the second bottom piece.

16. The supporting apparatus of claim 15, wherein the second side piece is perpendicular to the second top piece and the second bottom piece.
